(19) United States
(12) Patent Application Publication
(10) Pub. No.: US 2013/0270381 A1
(43) Pub. Date: Oct. 17, 2013

(54) METHOD FOR STORING AN ELEMENTARY SEMI-FINISHED ELEMENT IN A PLANT FOR PRODUCING TYRES AND DEVICE THEREFOR

(71) Applicants: Cesare Emanuele Amurri, Milano (IT); Maurizio Marchini, Milano (IT)

(72) Inventors: Cesare Emanuele Amurri, Milano (IT); Maurizio Marchini, Milano (IT)

(21) Appl. No.: 13/996,900

(22) PCT Filed: Dec. 15, 2011
(86) PCT No.: PCT/IB11/55699

§ 371 Date: Jun. 21, 2013

Related U.S. Application Data
(60) Provisional application No. 61/434,605, filed on Jan. 20, 2011.

(30) Foreign Application Priority Data
Dec. 22, 2010 (IT) MI2010A002351

(51) Int. Cl. B65H 54/02; B29D 30/00; B65H 59/00

(52) U.S. Cl. CPC B65H 54/026; B65H 59/00; B29D 30/0016
USPC 242/418; 242/472.8; 242/416

(57) ABSTRACT

A method and device for the storing of an elementary semifinished element in a plant for the differentiated production of tyres, wherein the elementary semifinished element is deposited, associated with a service film, on a collection support, into coils substantially disposed in side by side relationship forming adjacent layers deposited in opposite spiralling directions, at a predetermined winding angle, and wherein winding portions are present that are obtained by depositing the elementary semifinished element at a winding angle substantially equal to 0, for a circumferential angle less than 360°, in the transition between different spiraling directions. The winding angle is determined as a function of the dimensional parameters of the collection support and the elementary semifinished element.

The present invention relates to a method and a device for the storing of an elementary semifinished product on collection supports, in association with a service film, in a tyre building plant. The production cycles of a tyre contemplate that, subsequently to a building process in which the different tyre components are manufactured and/or assembled in one or more building lines, a vulcanisation and moulding process is carried out which is adapted to define the tyre structure according to a desired geometry and tread pattern.

A tyre generally comprises a torically ring-shaped carcass, including one or more carcass plies, reinforced with reinforcing cords lying in substantially radial planes (the radial plane contains the tyre rotation axis). Each carcass ply has its ends integrally associated with at least one annular reinforcing structure made of metal and referred to as “bead core”, which constitutes the reinforcing element of the beads, i.e. of the radially internal ends of the tyre, the function of which is to enable assembly of the tyre to a corresponding mounting rim. A band of elastomeric material, referred to as “tread band” is placed crown-wise to said carcass and formed in it is a raised pattern for ground contact, at the end of the vulcanisation and moulding steps. A reinforcing structure generally known as belt structure or “breaker” is interposed between the carcass and tread band. This breaker usually comprises, in case of car tyres, at least two radially superposed strips of rubberised film provided with reinforcing cords, usually of metal, disposed parallel to each other in each strip and crossed with the cords of the adjacent strip, preferably symmetrically relative to the equatorial tyre plane. Preferably the belt structure, at a radially external position, at least on the ends of the underlying belt strips, also comprises a third layer of textile or metallic cords, that are disposed circumferentially (at 0 degrees).

Finally, in tyres of the tubeless type there is a radially internal layer, referred to as liner, which has impermeability features for ensuring air-tightness to the tyre.

Within the present specification and the following claims, by the term “elastomeric material” it is intended a composition comprising at least one elastomeric polymer and at least one reinforcing filler. Preferably, this composition further comprises additives such as cross-linking agents and/or plasticizers. Due to the presence of the cross-linking agents, this material can be cross-linked by heating, so as to form the final article of manufacture.

In the following of the present specification and in the following claims the term “elongated element”, when not differently specified, is understood as indicating an element of elastomeric material having a major extension along a longitudinal direction thereof. This elongated element can comprise textile or metallic reinforcing cords embedded in a matrix of elastomeric material.

In the present specification and in the following claims, the expression “elementary semifinished elements” means continuous elongated elements of elastomeric material internally having at least one textile or metallic reinforcing cord and/or strips of elastomeric material generally referred to as “strip-like elements”, obtained by cutting said continuous elongated elements to size.

Generally these elementary semifinished elements are deposited in mutual side by side relationship on a substantially cylindrical and/or substantially toroidal deposition surface, for example contributing in forming carcass plies, belt strips and some types of reinforcing elements.

In the present specification and in the following claims, by “differentiated production” of a plant it is intended the possibility of using, in the production of each tyre, elementary semifinished elements that are different in size and/or type of elastomeric material and/or type of textile or metallic reinforcing cord.

In the following of the present invention by the expression “nominal diameter” of a storing device it is intended the outer diameter of the winding core of this device, i.e. related to the deposition surface of an element measured before winding of the element itself.

WO 09/040594 in the name of the same Applicant, shows a plant and a process for tyre production in which different independent production units are suitably integrated and synchronised with each other in order to form different tyre types and sizes. The process described in this document, contemplates use of elementary semifinished elements that are different for each tyre to be produced, and are supplied from feeding units operatively associated with the work stations.

GB 882,503 discloses an apparatus for simultaneous winding of an elongated element and a service film on a storing device. The elongated element comprises reinforcing cords embedded in a matrix of elastomeric material. This elongated element is used for making carcass plies for tyre production. The apparatus comprises a device for feeding the elongated element to the storing device and a device for feeding the service film to said storing device. Rotation of the storing device causes simultaneous winding, on the device itself, of the elongated element and the service film. The service film, in particular, will be interposed between the superposed coils of the elongated element.

EP 0 649 807 discloses a method and an apparatus for winding a ribbon-like element that is used for producing tyres, such as a rubberised sheet containing reinforcing threads/wires or cords or a nylon strip.

The Applicant has observed that in building plants like those described in WO 09/040594, designed to make tyres having very different technological requirements from each other, it is convenient that an elementary semifinished element should be selected from the different types at the moment of use, without stopping the building process.

In this context, the Applicant believes that it is advantageous to provide the different work stations with the elementary semifinished elements through feeding devices, which elementary semifinished elements have been preferably previously prepared and/or stored and are made available for the intended working with great flexibility.

The Applicant has further ascertained that the storing devices like those described in GB 882,503 involve some drawbacks for use in feeding work stations of the type present in plants for the differentiated production of tyres, due to a limited availability in terms of amounts of the individual elementary semifinished element.

In particular, the Applicant has perceived that it is advantageous to supply the different work stations through a plurality of feeding devices, each characterised by a high ability of storing the individual semifinished element, so as to reduce the plant's inactivity time due to replacement of the feeding devices, thereby increasing productivity of the plant itself.

The Applicant has further observed that, in processes including deposition of the elementary semifinished elements in mutually approached relationship on a deposition surface for making some tyre components, the building cycle time of these components depends on the transverse size of the elementary semifinished element itself.

The Applicant has therefore perceived the necessity to use elementary semifinished elements characterised by a greater transverse size as compared with the transverse size of the elementary semifinished elements used in known processes, so as to further increase the productivity of the above described processes.

In relation to these requirements, the Applicant has sensed the possibility of using feeding devices characterised by greater sizes, both in the radial and in the axial directions, relative to the feeding devices used in processes of the above depicted type.

The Applicant has verified that use of said feeding devices for the storing of elementary semifinished elements with sizes of the above highlighted type wound on the feeding device following the known methods, involves problems of quality apparently ascribable to the bigger sizes of the elementary semifinished elements.

The Applicant has further verified that these problems, although reduced, were not solved in a satisfactory manner also by carrying out control of the tension applied to the elementary semifinished element, before winding it on the storing device.

Therefore the Applicant has felt the necessity to develop a method for control of the storing of elementary semifinished elements, as well as a storing and feeding device that, upon application in a plant for differentiated production of tyres, enables control of the winding of the elementary semifinished element on a collection support, in association with a service film, so as to obtain an optimal storing and feeding system of the work stations of the plant and therefore reach an improvement in the quality levels of the tyre and the plant productivity.

The Applicant has therefore found that by adjusting the winding of an elementary semifinished element on a collection support, as a function of particular dimensional parameters of the support and of the elementary semifinished element, it is possible to obtain a uniform winding substantially without residual tensions of the semifinished element.

Accordingly, in a first aspect the present invention refers to a method for controlling the storing of an elementary semifinished element in a plant for the differentiated production of tyres, said method comprising:
providing at least one collection support for the storing of elementary semifinished elements;
forming a plurality of repeated units on said collection support, by deposition of said elementary semifinished element, associated with a service film, into coils substantially side-by-side, wherein each of said repeated units includes:
   at least two adjacent layers deposited in opposite spiralling directions, in a preset winding angle θ which is not 0°;
   at least two portions of winding obtained by depositing said elementary semifinished element on said collection support at a winding angle θ substantially equal to 0°, for a circumferential angle ω less than 360°, in the transition between two different spiralling directions.

The Applicant thinks that, according to this method for control of the storing of an elementary semifinished element, said elementary semifinished element once unwound from the collecting support and made available for the intended working, appears to be substantially devoid of deformation.

Therefore the Applicant believes that it is reduced the risk of generating scraps of material and/or creating faults in the final products in which this elementary semifinished element will be used.

In accordance with a second aspect, the invention relates to a storing and feeding device for an elementary semifinished element for use in a plant for the differentiated production of tyres, said device comprising, under load conditions:
a collection support for an elementary semifinished element;
a plurality of repeated units obtained by depositing said elementary semifinished element, associated with a service film, into coils substantially side-by-side on said collection support, each of said repeated units including:
   at least two adjacent layers deposited in opposite spiralling directions, in a preset winding angle θ which is not 0°;
   at least two portions of winding obtained by depositing said elementary semifinished element on said collection support at a winding angle θ substantially equal to 0°, for a circumferential angle ω less than 360°.

The present invention, in at least one of the aforesaid aspects, can have at least one of the following preferred features, taken individually or in combination with others.

In a preferred embodiment of the present invention, the winding angle θ is defined as a function of at least one dimensional parameter of said at least one collection support and of said elementary semifinished element.

Preferably, the dimensional parameter of said at least one collection support corresponds to the nominal diameter of each collection support.

Preferably, the dimensional parameter of said elementary semifinished element corresponds to a transverse dimension of the elementary semifinished element.

In a preferred embodiment of the present invention, provision is made for:
reducing the load acting on at least one portion of said elementary semifinished element prior to said depositing of the elementary semifinished element.

A further preferred embodiment of the present invention also comprises:
providing at least one depositing device for depositing said elementary semifinished element;
providing at least one feed system for said elementary semifinished element designed to be interlocked with said at least one depositing device in a defined feed direction, said feed system comprising at least one speed compensating device which engages at least one portion of said elementary semifinished element;
inserting a tension reducing device acting on said speed compensating device.

Preferably, said speed compensating device comprises a plurality of idler rollers.

More preferably, said tension reducing device comprises at least one motor unit designed to drive rotation in the feed direction of the elementary semifinished element.

Preferably, said motor unit is characterised by a constant torque.

In a preferred embodiment, said service film is taken from a storage reel by rotation of said collection support.

More preferably, said service film is designed to be removed from the elementary semifinished element prior to final use of the latter.

Preferably, said service film comprises polyethylene terephthalate or polyester.

In a particularly preferred embodiment, provision is made for assembling at least one component of a tyre, wherein this component is obtained starting from said elementary semifinished element unwound from at least one collection support.

Further features and advantages of the present invention will become more apparent from the following detailed description of some preferred embodiments of a method and a device according to the present invention, taken with reference to the accompanying drawings. In these drawings:

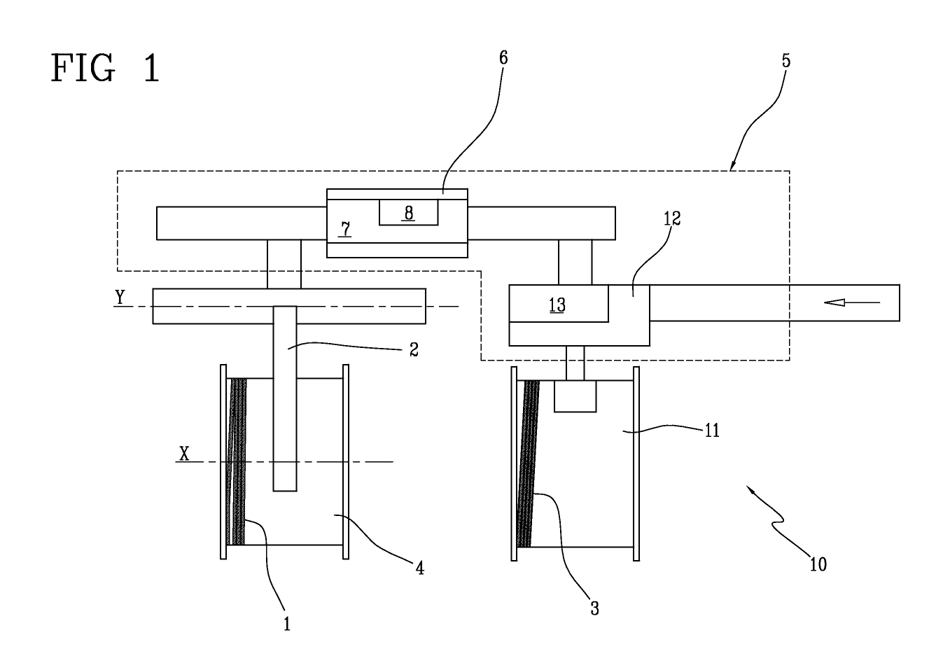

FIG. 1 is a diagrammatic view of an apparatus for deposition of an elementary semifinished element on a storing device, in accordance with the present invention;

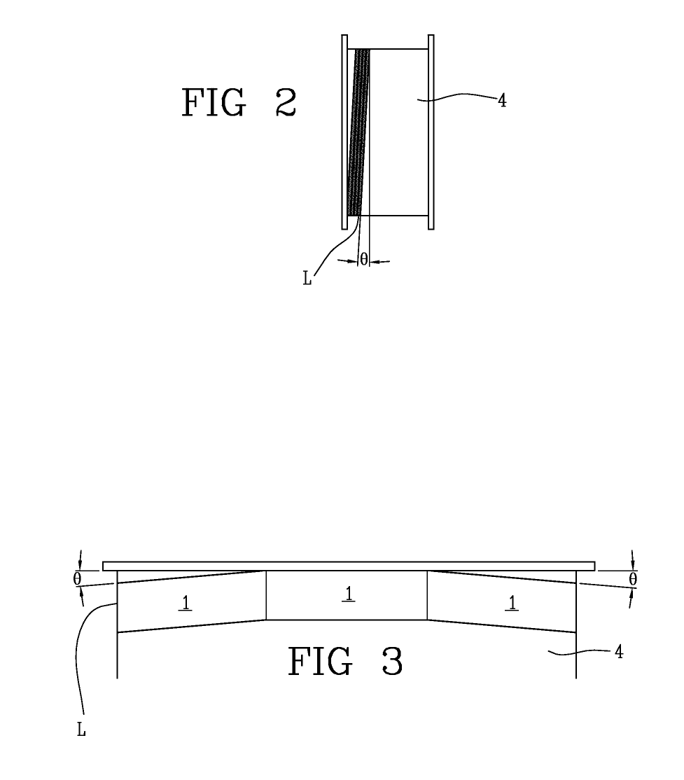

FIG. 2 is a diagrammatic view of a portion of the storing device in accordance with the present invention;

FIG. 3 is a diagrammatic view of a portion of elementary semifinished element deposited on the storing device, in accordance with the present invention.

In FIG. 1, an embodiment given by way of example of an apparatus for deposition of an elementary semifinished element 1 on a collection support with interposition of a service film 3 has been generally identified with reference numeral 10.

This apparatus 10 is in particular used in a process for production of a tyre for vehicle wheels, in association with other apparatus. This process is in particular intended for formation of carcass plies, belt strips and some types of reinforcing elements, through mutual approaching of portions of an elementary semifinished element 1 on a substantially cylindrical and/or substantially toroidal deposition surface.

The elementary semifinished element 1 is obtained by a conventional extrusion process, preferably carried out upstream of apparatus 10, in line with the deposition carried out by apparatus 10.

Preferably said elementary semifinished element 1 has a transverse size (L) greater than or equal to about 15 mm.

Preferably, said elementary semifinished element 1 has a transverse size (L) smaller than or equal to about 60 mm.

Preferably, said elementary semifinished element 1 has a transverse size (L) included between about 15 mm and about 60 mm, extremes included.

Preferably, said elementary semifinished element 1 has a transverse size (L) included between about 25 mm and about 40 mm, extremes included.

The apparatus 10 comprises a deposition device 2, movable relative to said apparatus 10 and adapted to deposit the elementary semifinished element 1 on a collection support 4.

Preferably, the deposition device 2 comprises actuating devices enabling translation movements to be carried out on an axis “Y” parallel to axis “X” of said collection support 4, as well as rotation movements around said axis “Y”.

The collection support 4 is movable relative to apparatus 10 and comprises a winding or unwinding core of nominal diameter (D) the value of which is preferably greater than or equal to about 600 mm.

Preferably, the value of the nominal diameter (D) is greater than or equal to about 1 m.

In a preferred embodiment, the rotation movement of the collection support 4 is operated by a suitable motor unit (not shown).

As diagrammatically shown in FIG. 1, provided upstream of apparatus 10 is a feed system 5 for supply of the elementary semifinished element 1, which system is adapted to bring said elementary semifinished element 1 from the extrusion devices (not shown) to apparatus 10, as well as to be interlocked with said deposition device 2.

The feed system 5 in a preferred embodiment comprises a speed compensating device 6 engaging a portion of said elementary semifinished element 1 and adapted to balance the speed of the portion of elementary semifinished element 1 coming out of the extrusion devices, with the deposition speed of the elementary semifinished element itself on the collection support 4.

In a preferred embodiment, said speed compensating device 6 comprises a plurality of idler rollers 7.

In a further preferred embodiment, a tension reducing device 8 is provided which is applied to the speed compensating device 6 and is adapted to impart a force in the feed direction of the elementary semifinished element 1 so as to enable reduction in the load acting on the elementary semifinished element 1.

Preferably, said tension reducing device 8 is placed close to one of the plurality of idler rollers 7.

In a further preferred embodiment said tension reducing device 8 comprises a motor unit 9, preferably having a constant torque.

Apparatus 10 further comprises a storage reel 11 for the service film 3, and a feeding device 12 adapted to bring said service film 3 from the storage reel 11 to the deposition device 2. Preferably, the service film 3 comprises polyethylene terephthalate or polyester.

In a preferred embodiment, the service film 3 is unwound from the storage reel 11 due to the pulling action exerted by the collection support 4, when the latter is set in rotation.

In a further embodiment, the service film 3 is unwound from the storage reel 11 by rotation of the reel 11 itself, carried out by a motor unit (not shown) applied to the storage reel 11.

Advantageous, the feeding device 12 is placed between the collection support 4 and the storage reel 11 and comprises a second series of idler rollers 13.

In a preferred embodiment, at a roller belonging to said second series of idler rollers 13, a motor unit (not shown) is active which is adapted to impart a force in the feed direction of the service film 3.

Operation of apparatus 10 is managed by a suitable control device (not shown) adapted to adjust the rotation speed of the collection support 4 and to determine a winding angle θ according to which the elementary semifinished element 1 associated with the service film 3 is deposited on the collection support 4.

This winding angle θ is calculated as a function of dimensional parameters characteristic of the collection support 4 and the elementary semifinished element 1.

In a preferred embodiment of the present invention, said winding angle θ is determined by the control device as a function of the transverse size (L) of the elementary semifinished element 1 and the value of the nominal diameter (D) of the collection support 4 according to the relation θ=arctg(L/πD).

Advantageously, said control device adjusts movement of the deposition device 2 as well as tension of the elementary semifinished element 1 and the service film 3, by acting on the responsible devices, such as said tension reducing device 8 and/or said motor unit acting on said second series of idler rollers 13.

The method for deposition of the elementary semifinished element 1 on the collection support 4 associated with the service film 3 is now described.

During preparation of apparatus 10, the collection support 4 under pre-load conditions and the storage reel 11 containing the service film 3 are placed in the suitable seats included in apparatus 10. The term “preload conditions” means an empty storage reel 11, i.e. without materials deposited thereon.

Subsequently, a limited portion of service film 3 is unwound from the storage reel 11 and wound on the outer surface of the winding core of the collection support 4.

Through the feed system 5, the end of the elementary semifinished element 1 is brought to the deposition device 2, which device 2 is subsequently positioned in the vicinity of the outer surface of the core of the collection support 4. In this manner, the end of the elementary semifinished element 1 is placed close to the portion of service film 3 previously deposited on said collection support 4, at an axially external starting position.

Following these operations, the collection support 4 is set in rotation and the elementary semifinished element 1 is wound on said support 2, together with the service film 3.

Preferably, said service film 3 is unwound from the storage reel 11 by the pulling action exerted by rotation of the collection support 4.

Preferably, deposition of said elementary semifinished element 1 joined to the service film 3 is carried out in the form of coils substantially disposed in side by side relationship at a deposition angle θ different from 0° and takes place until suitable sensors (not shown) generate a signal identifying reaching of a predetermined limit of the deposition surface. Said limit preferably comprises the free extremity of the deposition surface, measured in the axial direction relative to the collection support 4.

On occurrence of generation of said identification signal, the control system adjusts movement of the deposition device 2 in such a manner that the latter stops its transverse movement and goes on depositing the elementary semifinished element 1 at a winding angle θ substantially equal to 0°, for a circumferential angle ω smaller than 360°.

Preferably said circumferential angle ω has a value less than or equal to about 315°.

Preferably said circumferential angle ω has a value greater than or equal to about 45°.

In a preferred embodiment of the present invention, said circumferential angle ω has a value included between about 45° and about 315°, extremes included.

After this winding for a circumferential angle ω less than 360°, the transverse movement of the deposition device 2 is restored in a way opposite to that followed in the previous step. The elementary semifinished element 1 is then deposited according to said angle θ different from 0°, in a spiralling direction substantially opposite to that adapted to form the previous layer.

A plurality of layers are then obtained going on repeating said actions: depositing the elementary semifinished element 1 to a predetermined winding angle θ different from 0°; stopping the transverse movement of the deposition device 2; carrying out deposition according to an angle θ substantially equal to 0° for a circumferential angle ω less than 360°; reverting the transverse movement of the deposition device 2 going on deposition to a winding angle θ different from 0° in a spiralling direction opposite to the previous one.

In a preferred embodiment this deposition process terminates when the maximum capacity of the collection support 2 is reached, depending on the sizes of the support itself.

Once the deposition process has been completed, feeding of the elementary semifinished element 1 and the service film to the collection support 4 is interrupted and said collection support 4 is removed from the provided seat and replaced with a new support 4 under pre-load conditions.

In a preferred embodiment of the present invention, the rotation speed of the collection support 4 can be advantageously determined by the control system, as a function of the geometric parameters and the physico-chemical features of the elements concerned with the deposition process.

1-30. (canceled)

31. A method for controlling storing of an elementary semifinished element in a plant for differentiated production of a tyre, comprising:
providing at least one collection support for the storing of elementary semifinished elements; and
forming a plurality of repeated units on said collection support, by deposition of said elementary semifinished element, associated with a service film, into coils substantially side-by-side, wherein each of said repeated units comprises:
at least two adjacent layers deposited in opposite spiralling directions, in a preset winding angle which is not 0°;
at least two portions of winding obtained by depositing said elementary semifinished element on said collection support at a winding angle substantially equal to 0°, for a circumferential angle less than 360°, in a transition between two different directions of spiralling.

32. The method according to claim 31, wherein said winding angle is defined as a function of at least one dimensional parameter of said at least one collection support and of said elementary semifinished element.

33. The method according to claim 32, wherein said at least one dimensional parameter of said at least one collection support corresponds to a nominal diameter of each support.

34. The method according to claim 32, wherein said at least one dimensional parameter of said elementary semifinished element corresponds to one transverse dimension of the elementary semifinished element.

35. The method according to claim 33, wherein a value of the nominal diameter of said at least one collection support is greater than or equal to about 600 mm.

36. The method according to claim 33, wherein a value of the nominal diameter of said at least one collection support is greater than or equal to about 1 m.

37. The method according to claim 34, wherein a value of the transverse dimension of said elementary semifinished element is greater than or equal to about 15 mm.

38. The method according to claim 34, wherein a value of the transverse dimension of said elementary semifinished element is less than or equal to about 60 mm.

39. The method according to claim 34 wherein a value of the transverse dimension of said elementary semifinished element is between about 15 mm and about 60 mm, extremes included.

40. The method according to claim 34, wherein a value of the transverse dimension of said elementary semifinished element is between about 25 mm and about 40 mm, extremes included.

41. The method according to claim 31, wherein said circumferential angle has a value greater than or equal to about 45°.

42. The method according to claim 31, wherein said circumferential angle has a value less than or equal to about 315°.

43. The method according to claim 31, wherein said circumferential angle has a value between about 45° and about 315°, extremes included.

44. The method according to claim 31, further comprising:
reducing a load acting on at least one portion of said elementary semifinished element prior to depositing of said elementary semifinished element.

45. The method according to claim 44, further comprising:
providing at least one depositing device for depositing said elementary semifinished element;
providing at least one feed system for said elementary semifinished element designed to feed said at least one depositing device in a defined feed direction, said feed system comprising at least one speed compensating device which engages at least one portion of said elementary semifinished element; and
inserting a tension reducing device acting on said speed compensating device.

46. The method according to claim 45, wherein said speed compensating device comprises a plurality of idler rollers.

47. The method according to claim 45, wherein said tension reducing device comprises at least one motor unit designed to drive rotation in a feed direction of the elementary semifinished element.

48. The method according to claim 47, wherein said motor unit has a constant torque.

49. The method according to claim 31, wherein said service film is taken from a storage reel by rotation of said collection support.

50. The method according to claim 31, wherein said service film comprises polyethylene terephthalate.

51. The method according to claim 31, comprising assembling at least one component of a tyre, wherein said component is obtained by starting from said elementary semifinished element unwound by at least one collection support.

52. A storing and feeding device for an elementary semifinished element for use in a plant for differentiated production of a tyre, comprising, in load conditions:
a collection support for an elementary semifinished element; and
a plurality of repeated units obtained by depositing said elementary semifinished element, associated with a service film, into coils substantially side-by-side on said collection support, each of said repeated units comprising:
at least two adjacent layers deposited in opposite spiralling directions, in a preset winding angle which is not 0°; and
at least two portions of winding obtained by depositing said elementary semifinished element on said collection support at a winding angle substantially equal to 0°, for a circumferential angle less than 360°.

53. The storing and feeding device according to claim 52, wherein said winding angle is defined as a function of at least one dimensional parameter of the storing device and of said elementary semifinished element.

54. The storing and feeding device according to claim 53, wherein said at least one dimensional parameter of said at least one collection support corresponds to a nominal diameter of said collection support.

55. The storing and feeding device according to claim 53, wherein said at least one dimensional parameter of said elementary semifinished element corresponds to a transverse dimension of the elementary semifinished element.

56. The storing and feeding device according to claim 54, wherein a value of said nominal diameter of said collection support is greater than or equal to about 600 mm.

57. The storing and feeding device according to claim 54, wherein a value of said nominal diameter of said collection support is greater than or equal to about 1 m.

58. The storing and feeding device according to claim 55 wherein a value of the transverse dimension of said elementary semifinished element is between about 15 mm and about 60 mm, extremes included.

59. The storing and feeding device according to claim 55, wherein a value of said transverse dimension of said elementary semifinished element is between about 25 mm and about 40 mm, extremes included.

60. The storing and feeding device according to claim 52, wherein said circumferential angle has a value between about 45° and about 315°, extremes included.
